(19) United States
(12) Patent Application Publication
(10) Pub. No.: US 2013/0282857 A1
(43) Pub. Date: Oct. 24, 2013

(54) Cloud Based Storage Synchronization Device

(71) Applicant: Ronald Allen STAMPER, Pelham, AL (US)

(72) Inventor: Ronald Allen STAMPER, Pelham, AL (US)

(21) Appl. No.: 13/863,262

(22) Filed: Apr. 15, 2013

Related U.S. Application Data
(60) Provisional application No. 61/635,181, filed on Apr. 18, 2012.

(51) Int. Cl. H04L 29/08

(52) U.S. Cl. CPC H04L 29/0854
USPC 709/216

(57) ABSTRACT

A cloud based storage synchronization device provides a convenient solution to share pictures, videos, and documents between an individual and technologically impaired people. The device is able to connect with wireless network through a wireless chipset and able to store data within an internal memory. Once the device is communicably coupled with a cloud based storage network, the device is able to retrieve a plurality of files from the cloud based storage network and store within the internal memory. Once the plurality of files is downloaded, a user of the device, who is technologically impaired, can view the plurality of files through a graphical user interface. The device is able to retrieve unlimited amount of the plurality of files into the internal memory, as the existing files within the internal memory is deleted from the internal memory and organized in place holders within the internal memory.

The current application claims a priority to the U.S. Provisional Patent application Ser. No. 61/635,181 filed on Apr. 18, 2012.

### FIELD OF THE INVENTION

The present invention relates generally to a network connected USB Device. More particularly, the present invention relates to a network connected USB device that syncs shared files from online cloud storage accounts to the USB device's internal memory.

### BACKGROUND OF THE INVENTION

Demands in data storage solutions have rapidly increased in the past several years. This situation is mostly attributed to the wide scale adoption of high speed internet connections, the steady decline of physical media, and the increased availability of digital media alternatives. Traditionally, users faced with storage limitations have to rely on purchasing additional storage devices or upgrading their existing hardware. Although this is still the standard protocol for extending existing storage capacity, newer alternatives have appeared that not only increases a user's storage capacity, but allow remote access to a user's files. This storage solution is known as cloud storage.

Cloud storage is modeled off networked online storage that allows for offsite storage of a user's data by a third party provider. By storing files on a cloud storage system, users gain the ability to remotely access and download files at their choosing. This provides several benefits over physical media storage solutions. With physical media, files are directly linked to the functionality and survivability of the device. If the physical device fails, the files are lost. The likelihood of a device failing is significantly increased with frequent movement. With cloud storage, users can safely store and back up their data as well as access it at where ever they have an internet connection. Additionally, users are able to share their files such as documents, movies, and pictures with their friends and families.

Although there are many devices dedicated to accessing and transferring files to and from a cloud storage service, many devices rely on users having a working familiarity of the device and the services. For individuals that did not grow up with a computer or who may consider themselves technologically impaired, these devices and their associated services may be difficult to operate for many and inaccessible for some.

It is thus the object of the present invention to introduce a device that utilizes cloud storage services to share files through a network connected USB device that is easily accessible to individuals who do not consider themselves technologically proficient.

### BRIEF DESCRIPTION OF THE DRAWINGS

FIG. 1 is a illustration showing the basic components and the their connections within the present invention.

FIG. 2 is a flow chart illustrating the basic overall method of the present invention.

FIG. 3 is a flow chart illustrating the method of accessing a USB connecting mass storage device.

FIG. 4 is a flow chart illustrating the method of connecting the USB connecting mass storage device with a wireless network.

FIG. 5 is a flow chart illustrating the method of connecting the USB connecting mass storage device with at least one cloud storage account.

FIG. 6 is a flow chart illustrating the method of verifying a cloud storage system folder, and the method of downloading a plurality of files, wherein a file capacity of the plurality of files is less than a storage capacity of the cloud storage system folder.

FIG. 7 is a flow chart illustrating the method of downloading allowable files of the plurality of files, wherein the file capacity of the plurality of files is more than the storage capacity of the cloud storage system folder.

FIG. 8 is a flow chart illustrating the method of downloading excess files of the plurality of files, wherein the file capacity of the plurality of files is more than the storage capacity of the cloud storage system folder.

### DETAIL DESCRIPTIONS OF THE INVENTION

All illustrations of the drawings are for the purpose of describing selected versions of the present invention and are not intended to limit the scope of the present invention.

The present invention offers a convenient solution for an individual to share pictures, videos, and documents with friends and family members that consider themselves technologically impaired or may not be particularly proficient with other advanced means of sharing information. The present invention functions similarly to the traditional universal serial bus (USB) storage device, but is able to format the internal memory to be compatible with the connecting electronic devices, automatically connects with wireless computing networks, synchronizes a user's selected files from at least one cloud storage account, utilizes an intuitive file directory system, and appears to have an unlimited internal storage capacity.

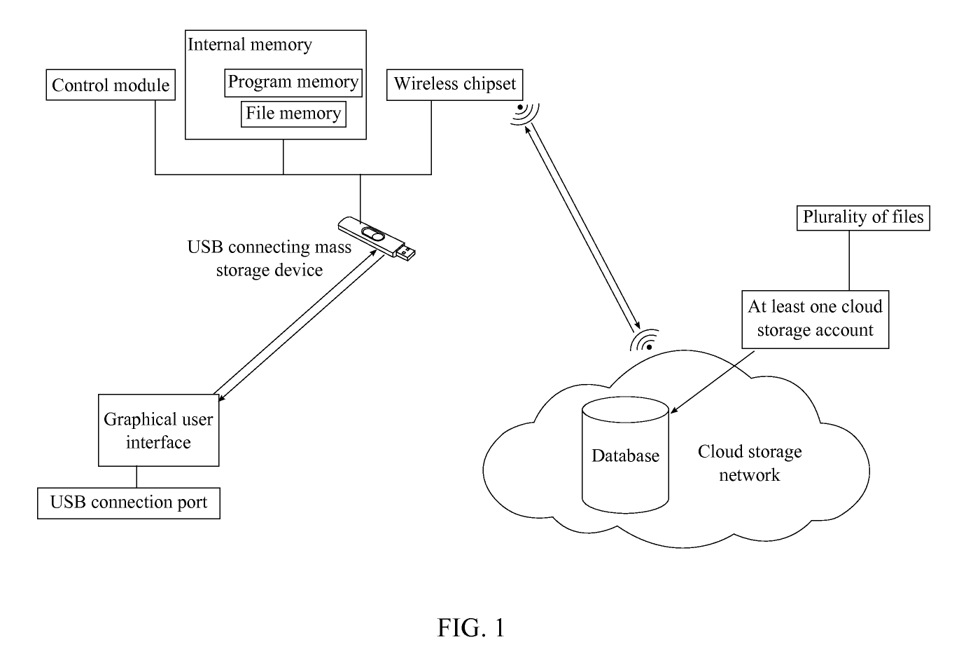

In reference to FIG. 1, the present invention, which is a universal serial bus (USB) connecting mass storage device, is intended to be used with a graphical user interface that recognizes the traditional USB storage devices. The graphical user interface includes, but not limited to, computers, televisions, set top boxes, gaming consoles, mobile devices, and other capable devices. The USB connecting mass storage device is intended to be compatible with all different universal serial bus (USB) connection port as the USB connection port is communicably coupled with the graphical user interface. The USB connecting mass storage device comprises a control module, a wireless chipset, and an internal memory, where the control module, the wireless chipset, and the internal memory are communicably coupled with each other within the USB connecting mass storage device. The control module is responsible for the core functionality of the present invention. The wireless chipset is compatible with current wireless standards which include but are not limited to wireless computing network, personal area computing network, and other wireless broadband connections. A file memory of the internal memory is used to store a plurality of files downloaded from the at least one cloud storage account as the at least one cloud storage account comprises the plurality of files, and the at least one cloud storage account is stored within a remote database. The file memory also allows for fast reading and writing capabilities of the plurality of files. A program memory of the internal memory is used store user account information, user defined settings, previously used settings of the present invention, the wireless chipset information, prior wireless network history, viewing history, and access history. Since the file memory is different from the program memory of the present invention, formatting of the file memory can take place within the present invention without formatting the program memory.

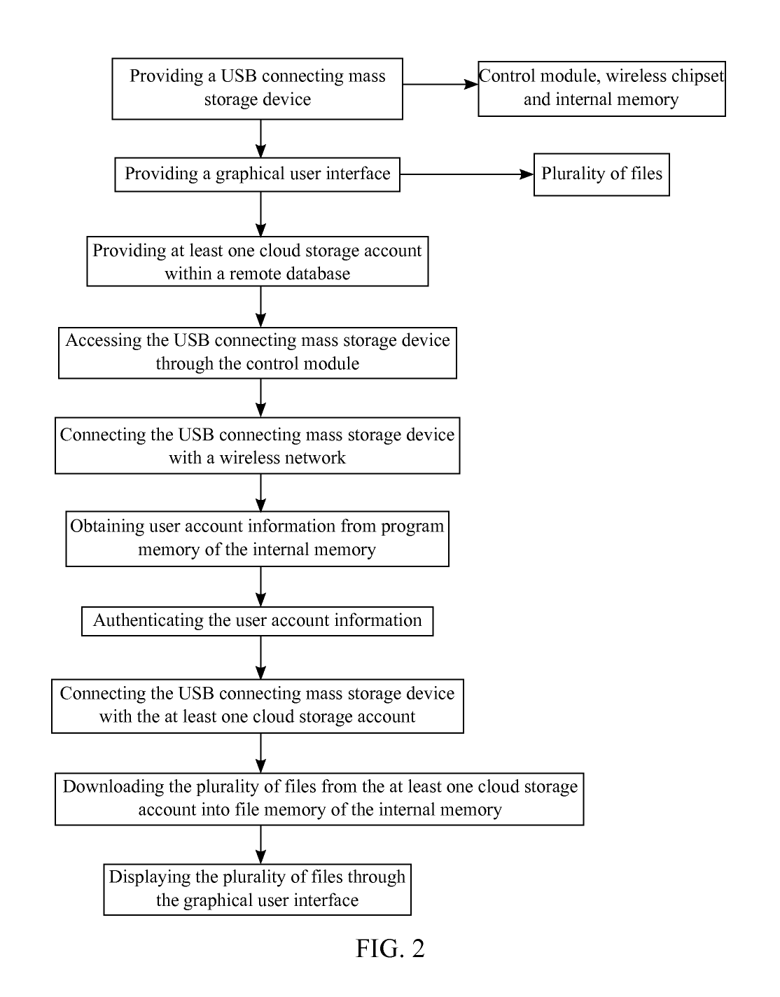

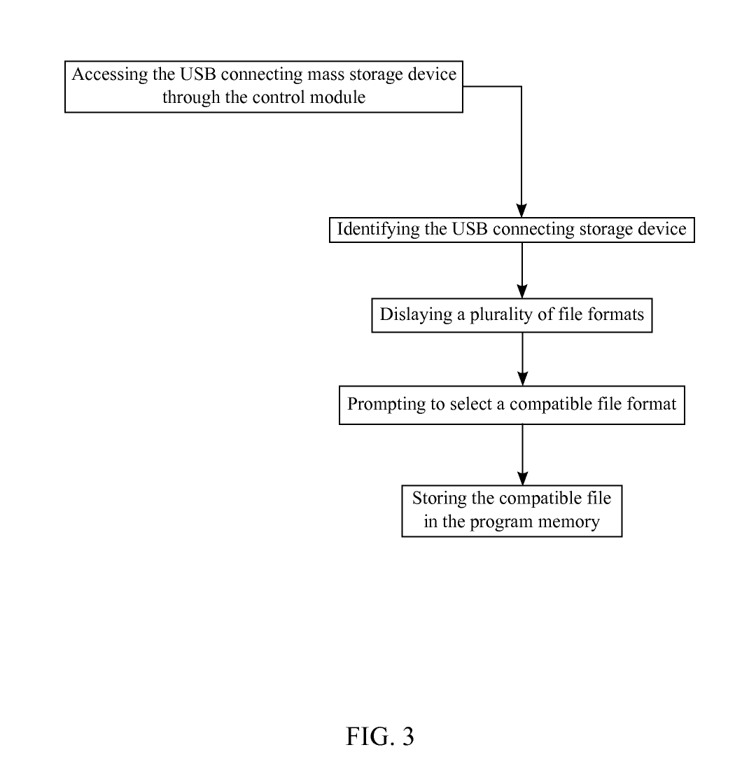

In reference to FIG. 2 and FIG. 3, the user of the present invention needs to insert the USB connecting mass storage device into the USB connection port of the graphical user interface so that the USB connecting mass storage device can be accessed through the control module by the software. Once the software identifies the USB connecting mass storage device, the software displays a plurality of file formats of the USB connecting mass storage device through the graphical user interface. Then the user is able to view the plurality of file formats, and the software prompts the user to select a compatible file format from the plurality of file formats according to the plurality of files. Once the compatible file format is selected, the compatible file format is stored in the program memory for future references. If the USB connecting mass storage device compatible with existing file formats of the plurality of file formats, the software does not display the plurality of file formats to the user.

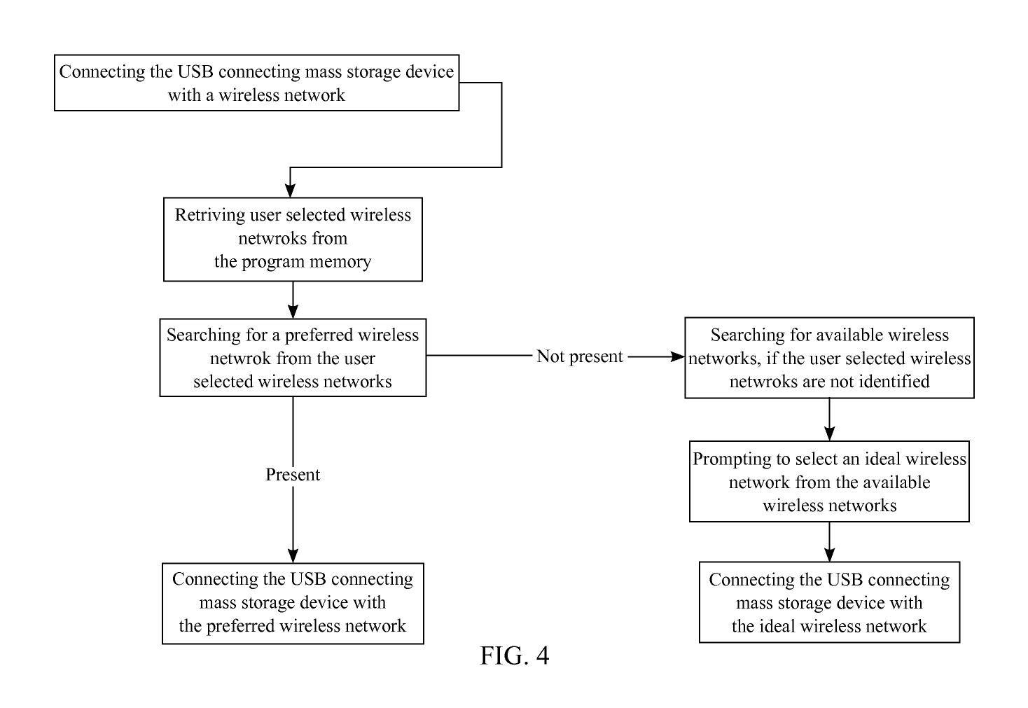

In reference to FIG. 2 and FIG. 4, the software retrieves user selected wireless networks from the program memory, where the user selected wireless networks are either saved to the prior wireless network history of the program memory from previous instances or saved to the prior wireless network history by inputting information. The software searches for a preferred wireless network from the user selected wireless networks so that the USB connecting mass storage device can be connected with the preferred wireless network. The software identifies the preferred wireless network if the any of the user selected wireless networks are available within the vicinity. Then the USB connecting mass storage device is communicably coupled with the preferred wireless network as the wireless chipset connects with the preferred wireless network. If the software can't find the user selected wireless networks, the software searches for available wireless networks so that the USB connecting mass storage device can be connected. The available wireless networks are displayed to the user through the graphical user interface and prompts the user to select an ideal wireless network form the available wireless networks. The USB connecting mass storage device can communicably couple with the ideal wireless network through the wireless chipset. If the software enables to find either the preferred wireless network or the available wireless networks, the USB connecting mass storage device doesn't connect with the wireless network. The present invention stops further progressions within the present invention but allows or denies the user to access the internal memory, where the access to the internal memory is pre-programmed within the program memory.

Then the software obtains the user account information from the program memory, where the user account information enables the USB connecting mass storage device to communicably coupled with the at least one cloud storage account. Then the user account information is authenticated by the software. If the software enables to authenticate the user account information at the initial instance, the software attempts to authenticate the user account information three more times. Once the user account information is authenticated by the software, the software connects the USB connecting mass storage device with the at least one cloud storage account through the user account information so that the plurality of files can be downloaded into the file memory from the at least one cloud storage account.

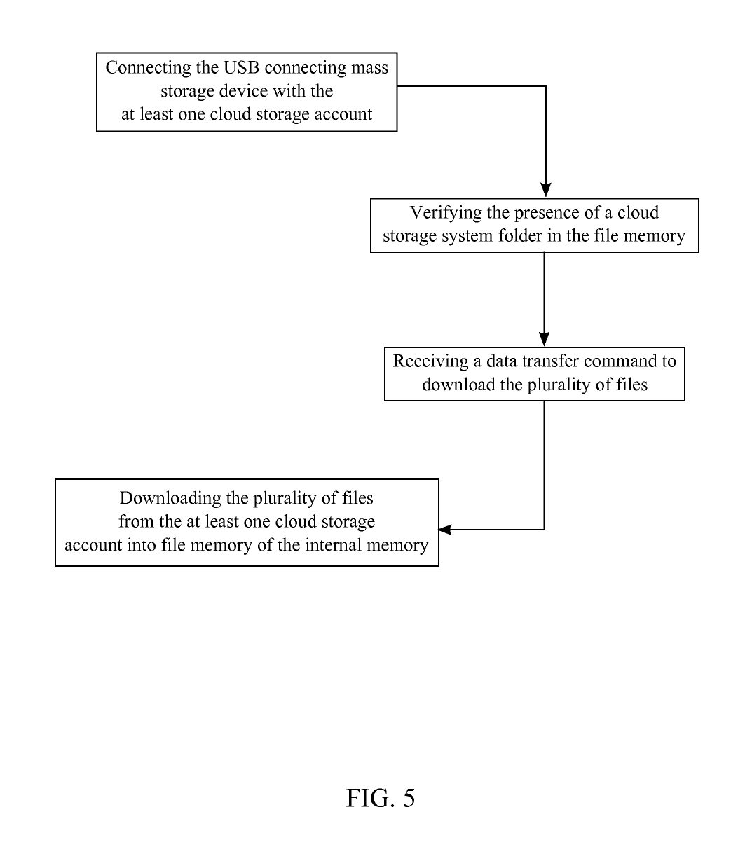

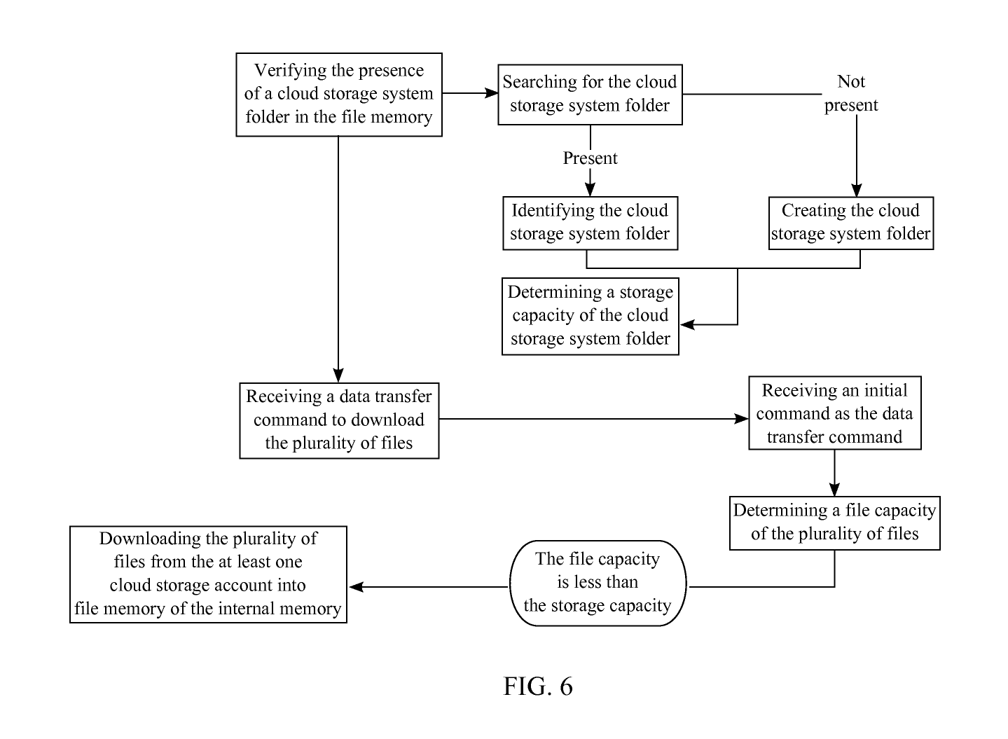

As shown in FIG. 5 and FIG. 6, in order to download the plurality of files, the software needs to verify the presence of a cloud storage system folder in the file memory so that the plurality of files can be downloaded into the cloud storage system folder from the at least one cloud storage account. Additionally, a data transferring command needs to be received from the user through the graphical user interface. Depending on the usage of the USB connecting mass storage device, the USB connecting mass storage device may or may not have the cloud storage system folder in the file memory. More specifically, if the software is able to find the cloud storage system folder in the file memory, the software identifies the cloud storage system folder and determines a storage capacity of the cloud storage system folder. If the software is unable to find the cloud storage system folder in the file memory, the software creates the cloud storage system folder and determines the storage capacity of the cloud storage system folder.

After the presence of the cloud storage system folder is accounted within the present invention and the data transferring command is received by the present invention, the software starts the downloading process for the plurality of files from the at least one cloud storage account into the cloud storage system folder. More specifically, once the software receives an initial command as the data transferring command to download the plurality of files, the software determines a file capacity of the plurality of files that need to be downloaded. Depending on the file capacity, the downloading process of the plurality of files differs from one another.

In reference to FIG. 6, if the file capacity of the plurality of files is less than the storage capacity of the cloud storage system folder, the plurality of files is directly downloaded into the cloud storage system folder from the at least one cloud storage account. Since the file capacity of the plurality of files does not exceed the storage capacity of the cloud storage system folder, the plurality of files can completely download within the present invention. Then the user is able to view the plurality of files as the plurality of files is displayed on the graphical user interface by the software.

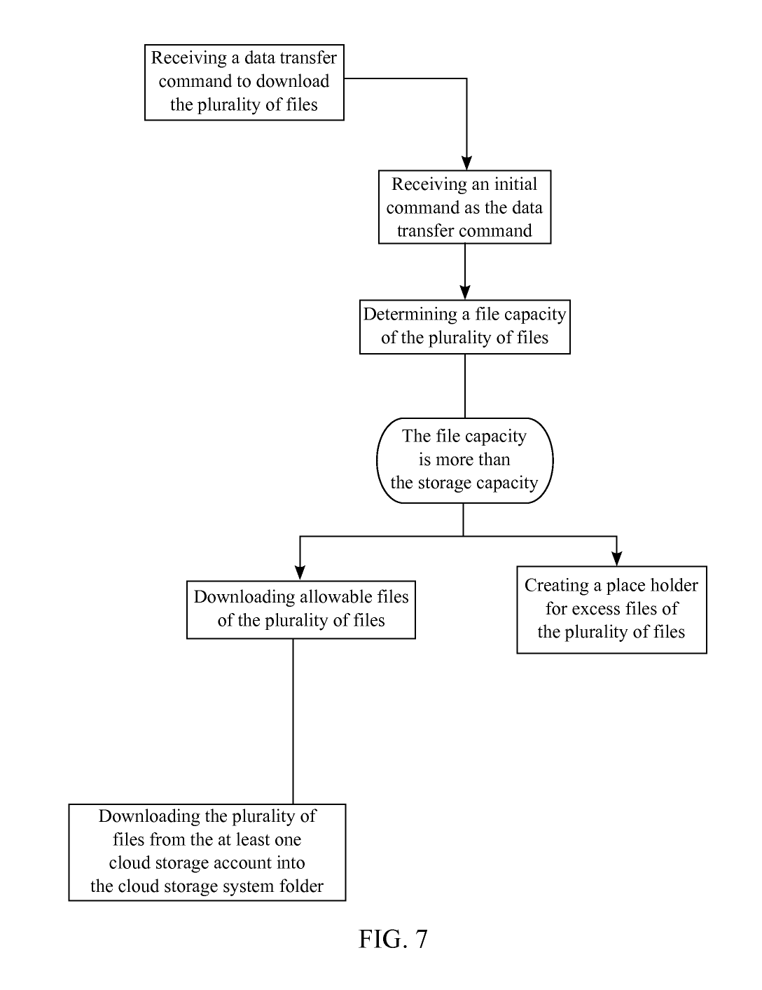

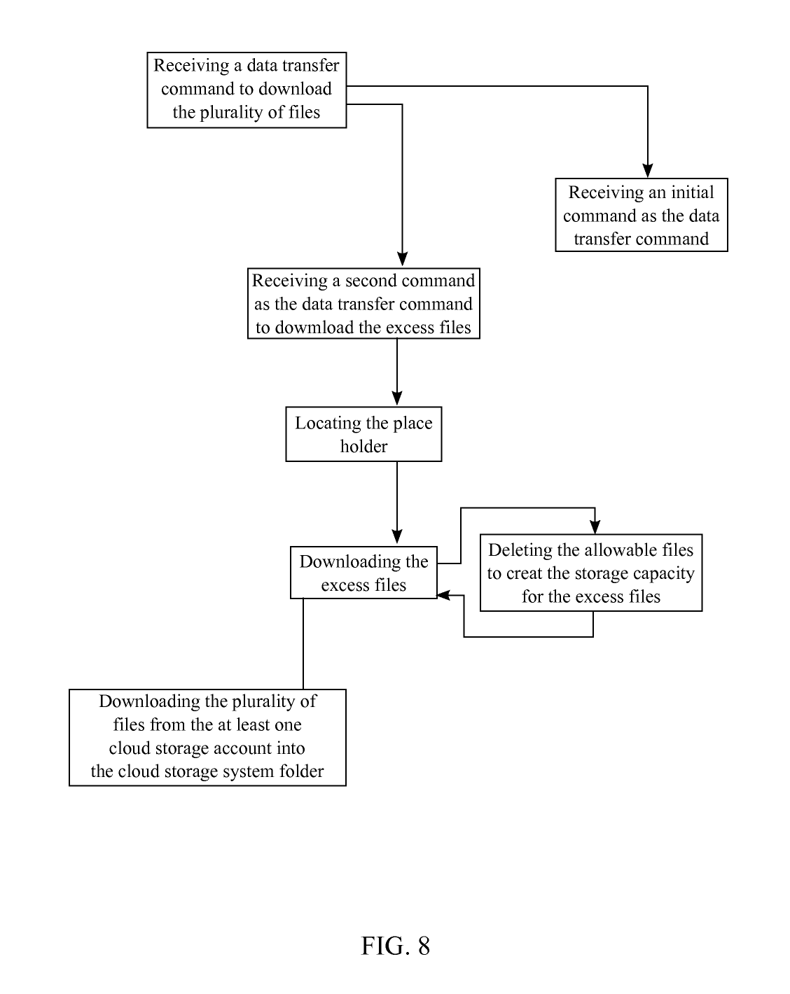

In reference to FIG. 7 and FIG. 8, if the file capacity of files exceeds the storage capacity of the cloud storage system folder, the plurality of files can not completely download into the cloud storage system folder from the at least one cloud storage account. Since the file capacity of the plurality of files exceeds the storage capacity of the cloud storage system folder, the plurality of files is partially download within the present invention. More specifically, upon the receiving the initial command, the software only downloads allowable files of the plurality of files, where the file capacity of the allowable files are less than the storage capacity of the cloud storage system folder. A place holder is created by the software within the cloud storage system folder so that the user can access excess files of the plurality of files. The allowable files and the place holder are displayed to the user through the graphical user interface by the software so that the user is able to view the allowable files and the place holder. Once the user finishes viewing the allowable files, the user can access the excess files. The software receives a second command as the data transfer command to download the excess files. The software then locates the place holder. In order to create storage capacity within the cloud storage system folder so that the excess files can be downloaded, the software deletes the allowable files while the excess files being downloaded into the cloud storage system folder. Once all or some of the allowable files are deleted from the cloud storage system folder, the deleted allowable files are organized into a place holder with a distinctive name and stored in the viewing history.

When the user decides to download a second set of plurality of files from the at least one cloud storage account, the software organizes the plurality of files, which stores in the file memory, into a place holder with a distinctive name and stores in the viewing history so that the second set of files can be downloaded into the cloud storage system folder. In order to create storage capacity for the second set of plurality of files, the software deletes the plurality of files from the cloud storage system folder. Since the present invention continuously downloads data from the at least one cloud storage account upon the users request and creates place holders with distinctive names for the deleted data, the users of the present invention is able to continue uninterrupted data flow from the at least one cloud storage account. Due to the fact the present invention allows the user to view unlimited amount of data through the graphical user interface, the users of the present invention do not get restricted from the amount of data that can be downloaded from the at least one cloud storage account.

When the present invention comprises multiple cloud storage accounts, The USB connecting mass storage device downloads the plurality of files based on the presence or absence of the cloud storage system folder. The USB connecting mass storage device first downloads the plurality of files into existing cloud storage system folders of the respective cloud storage accounts. Then the plurality of files is downloaded into the created cloud storage system folders of the respective cloud storage accounts. The user can also organize the order of downloading process from one cloud storage account into next cloud storage account.

When the USB connecting mass storage device comprises multiple cloud storage system folders with respect to the multiple cloud storage accounts, the USB connecting mass storage device shows all of the multiple cloud storage system folders to the user through the graphical user interface. When the user selects a desired cloud storage system folder, the software begins a quick formatting process that allocates the majority of the storage space to the desired cloud storage system folder. The software then records the desired cloud storage system folder and the associated graphical user interface information in the program memory while automatically formatting the access history of the program memory so that the associated graphical user interface seamlessly can reconnect with the USB connecting mass storage device again. Then the software hides the other cloud storage system folders and only displays the desired cloud storage system folder.

Although the invention has been explained in relation to its preferred embodiment, it is to be understood that many other possible modifications and variations can be made without departing from the spirit and scope of the invention as hereinafter claimed.

What is claimed is:

1. A method of file sharing through cloud computing with a network connecting storage device by executing computer-executable instruction stored on a non-transitory computer-readable medium, the method comprises the steps of:
providing a universal serial bus (USB) connecting mass storage device, wherein the USB connecting mass storage device comprise a control module, a wireless chipset, and an internal memory that are communicably coupled with each other;
providing a graphical user interface with a communicably coupled universal serial bus (USB) connection port, wherein the USB connection port is communicably coupled with the USB connecting mass storage device;
providing at least one cloud storage account stored within a remote database, wherein the at least one cloud storage account comprises a plurality of files;
accessing the USB connecting mass storage device through the control module;
connecting the USB connecting mass storage device with a wireless network through the wireless chipset;
obtaining user account information from a program memory of the internal memory, wherein the user account information enable the USB connecting mass storage device to communicably coupled with the at least one cloud storage account;
authenticating the user account information;
connecting the USB connecting mass storage device with the at least one cloud storage account through the user account information;
downloading the plurality of files from the at least one cloud storage account into a file memory of the internal memory; and
displaying the plurality of files through the graphical user interface.

2. The method of file sharing through cloud computing with a network connecting storage device by executing computer-executable instruction stored on a non-transitory computer-readable medium, the method as claimed in claim 1 comprises the steps of:
identifying the USB connecting mass storage device;
displaying a plurality of file formats of the USB connecting mass storage device through the graphical user interface;
prompting to select a compatible file format from the plurality of file format according to the plurality of files; and
storing the compatible file format in the program memory.

3. The method of file sharing through cloud computing with a network connecting storage device by executing computer-executable instruction stored on a non-transitory computer-readable medium, the method as claimed in claim 1 comprises the steps of:
retrieving user selected wireless networks from the program memory;
searching for a preferred wireless network from the user selected wireless networks;
identifying the preferred wireless network, if the user selected wireless networks are identified; and
connecting the USB connecting mass storage device with the preferred wireless network through the wireless chipset.

4. The method of file sharing through cloud computing with a network connecting storage device by executing computer-executable instruction stored on a non-transitory computer-readable medium, the method as claimed in claim 1 comprises the steps of:
retrieving user selected wireless networks from the program memory;
searching for a preferred wireless network from the user selected wireless networks; and
connecting the USB connecting mass storage device with the preferred wireless network through the wireless chipset.

5. The method of file sharing through cloud computing with a network connecting storage device by executing computer-executable instruction stored on a non-transitory computer-readable medium, the method as claimed in claim 4 comprises the steps of:
searching for available wireless networks, if the user selected wireless networks are not identified;
prompting to select an ideal wireless network from the available wireless networks; and
connecting the USB connecting mass storage device with the ideal wireless network through the wireless chipset.

6. The method of file sharing through cloud computing with a network connecting storage device by executing computer-executable instruction stored on a non-transitory computer-readable medium, the method as claimed in claim 1 comprises the steps of:
verifying the presence of a cloud storage system folder in the file memory;
receiving a data transfer command to download the plurality of files; and
downloading the plurality of files into the cloud storage system folder from the at least one cloud storage account.

7. The method of file sharing through cloud computing with a network connecting storage device by executing computer-executable instruction stored on a non-transitory computer-readable medium, the method as claimed in claim 6 comprises the steps of:
searching for the cloud storage system folder;
identifying the cloud storage system folder;
determining a storage capacity of the cloud storage system folder;
receiving an initial command as the data transfer command to download the plurality of files;
determining a file capacity of the plurality of files; and
downloading the plurality of files into the cloud storage system folder, if the file capacity of the plurality of files is less than the storage capacity of the cloud storage system folder.

8. The method of file sharing through cloud computing with a network connecting storage device by executing computer-executable instruction stored on a non-transitory computer-readable medium, the method as claimed in claim 6 comprises the steps of:
searching for the cloud storage system folder;
identifying the cloud storage system folder;
determining a storage capacity of the cloud storage system folder;
receiving an initial command as the data transfer command to download the plurality of files;
determining a file capacity of the plurality of files;
downloading allowable files of the plurality of files into the cloud storage system folder, if the file capacity of the plurality of files exceeds the storage capacity of the cloud storage system folder;
creating a place holder within the file memory for excess files of the plurality of files;
receiving a second command as the data transfer command to download the excess files;
locating the place holder;
downloading the excess files of the plurality of files into the cloud storage system folder; and
simultaneously deleting the allowable files to create the storage capacity for the excess files.

9. The method of file sharing through cloud computing with a network connecting storage device by executing computer-executable instruction stored on a non-transitory computer-readable medium, the method as claimed in claim 6 comprises the steps of:
searching for the cloud storage system folder;
creating the cloud storage system folder in the file memory, if the cloud storage system folder is not located;
determining a storage capacity of the cloud storage system folder;
receiving an initial command as the data transfer command to download the plurality of files;
determining a file capacity of the plurality of files; and
downloading the plurality of files into the cloud storage system folder, if the file capacity of the plurality of files is less than the storage capacity of the cloud storage system folder.

10. The method of file sharing through cloud computing with a network connecting storage device by executing computer-executable instruction stored on a non-transitory computer-readable medium, the method as claimed in claim 6 comprises the steps of:
searching for the cloud storage system folder;
creating the cloud storage system folder in the file memory, if the cloud storage system folder is not located;
determining a storage capacity of the cloud storage system folder;
receiving an initial command as the data transfer command to download the plurality of files;
determining a file capacity of the plurality of files;
downloading allowable files of the plurality of files into the cloud storage system folder, if the file capacity of the plurality of files exceeds the storage capacity of the cloud storage system folder;
creating a place holder within the file memory for excess files of the plurality of files;
receiving a second command as the data transfer command to download the excess files;
locating the place holder;
downloading the excess files of the plurality of files into the cloud storage system folder; and
simultaneously deleting the allowable files to create the storage capacity for the excess files.
